(19) United States
(12) Patent Application Publication
(10) Pub. No.: US 2023/0192916 A1
(43) Pub. Date: Jun. 22, 2023

(54) HYDROPHILIZING TREATMENT AGENT

(71) Applicant: NIPPON PAINT SURF CHEMICALS CO., LTD., Tokyo (JP)

(72) Inventors: Ken TAMAMOTO, Tokyo (JP); Souhei KANEKO, Tokyo (JP)

(21) Appl. No.: 17/925,735

(22) PCT Filed: May 17, 2021
(86) PCT No.: PCT/JP2021/018538

§ 371 Date: Nov. 16, 2022

(30) Foreign Application Priority Data
May 29, 2020 (JP) 2020-094946

(51) Int. Cl. C08F 20/26; C08F 20/38; C08F 2/26

(52) U.S. Cl. CPC C08F 20/26; C08F 2/26; C08F 20/38

(57) ABSTRACT

Provided is a hydrophilizing treatment agent capable of forming a hydrophilic coating film in which the preferred hydrophilicity and antifogging properties are obtained and which has exceptional moist heat resistance and scratch resistance. A hydrophilizing treatment agent that includes: a hydrophilic polymer (A) having at least one of an alkoxysilyl group and a hydrolysate thereof, and also having a betaine structure, in each molecule; and a hydrophilic polymer (B) that is a hydrophilic polymer having an ionic functional group and/or a non-ionic hydrophilic polymer. B/(A+B) is 1.0-51.0%. The preferred moist heat resistance and scratch resistance of the hydrophilic coating film formed by the hydrophilizing treatment agent are obtained due to the hydrophilic polymer (A) and the hydrophilic polymer (B) forming an ionically crosslinked network or a dipole-dipole interaction network.

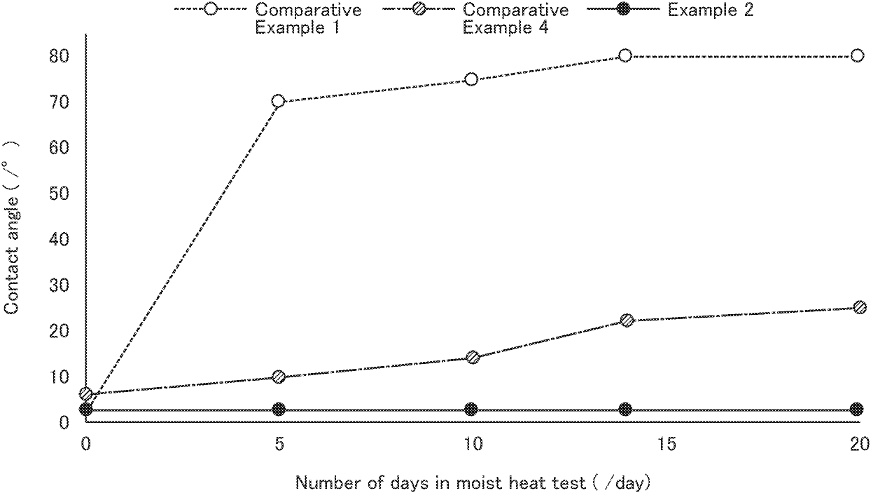

### TECHNICAL FIELD

The present invention relates to a hydrophilizing agent.

### BACKGROUND ART

Conventionally, those containing a silicate oligomer or silica gel have been known as hydrophilizing agents providing an anti-fog property to a substrate such as glass. Furthermore, a hydrophilizing agent having a betaine structure has also been known (e.g., see Patent Document 1).

Patent Document 1: PCT International Publication No. WO2014/084219

Patent Document 1 discloses a hydrophilic coating agent produced by polymerizing a betaine monomer and a monomer component containing an alkoxysilyl group-containing compound. A film formed from the above-mentioned hydrophilic coating agent is described to have an excellent anti-fog property and abrasion resistance. However, conventional hydrophilic coating agents including the technology disclosed in Patent Document 1 have a problem in that the resulting hydrophilic films easily deteriorate in an anti-fog property under a moist heat environment. Furthermore, there still is room for improvement in scratch resistance of the hydrophilic film.

### DISCLOSURE OF THE INVENTION

### Problems to Be Solved by the Invention

The present invention has been made in view of the above and an object of the present invention is to provide a hydrophilizing agent that provides favorable hydrophilicity and anti-fog property and that allows formation of a hydrophilic film having excellent moist heat resistance and scratch resistance.

### Means for Solving the Problems

The present invention relates to a hydrophilizing agent including a hydrophilic polymer (A) having a betaine structure, and at least one selected from an alkoxysilyl group and a hydrolysate thereof in a molecule; and a hydrophilic polymer (B) being at least one selected from a hydrophilic polymer having an ionic functional group and a non-ionic hydrophilic polymer having a polar functional group, with a ratio B/(A+B), a ratio of a solid mass of the hydrophilic polymer (B) to a total solid mass of the hydrophilic polymer (A) and the hydrophilic polymer (B), being 1.0 to 51.0%.

### Effects of the Invention

The present invention can provide a hydrophilizing agent that provides favorable hydrophilicity and anti-fog property and that allows formation of a hydrophilic film having excellent moist heat resistance and scratch resistance.

### BRIEF DESCRIPTION OF THE DRAWINGS

The FIGURE is a graph representing the results of moist heat tests using hydrophilizing agents according to Example and Comparative Examples of the present invention.

### PREFERRED MODE FOR CARRYING OUT THE INVENTION

One embodiment of the present invention will now be described. The present invention is not limited to the following embodiment.

### Hydrophilizing Agent

A hydrophilizing agent according to the present invention includes a hydrophilic polymer (A) having a betaine structure, and at least one selected from an alkoxysilyl group and a hydrolysate thereof in a molecule, and a hydrophilic polymer (B) being at least one selected from a hydrophilic polymer having an ionic functional group and a non-ionic hydrophilic polymer having a polar functional group. The hydrophilic polymer (A) and the hydrophilic polymer (B) form an ionically cross-linked network or a network based on dipole-dipole interaction in a hydrophilic film formed with the hydrophilizing agent. This provides favorable moist heat resistance and scratch resistance to the hydrophilic film.

### Hydrophilic Polymer (A)

A hydrophilic polymer (A) has a betaine structure and preferably has an alkoxysilyl group or a silanol group, at least at a terminal end in a molecule. The hydrophilic polymer (A) is produced by, for example, polymerizing a betaine monomer with a compound having an alkoxysilyl group or a silanol group.

The betaine monomer is a compound having a betaine structure in a molecule. The hydrophilic polymer (A) having the betaine structure in a molecule can provide a favorable anti-fog property to a hydrophilic film formed with the hydrophilizing agent. The betaine structure is composed of a cation and an anion in the same molecule of the betaine monomer. The cation is not particularly limited. Examples thereof include quaternary ammonium, sulfonium, phosphonium, etc. The anion is not particularly limited. Examples thereof include —SO₃⁻, —CO₂⁻, —PO₃H⁻, —OPO₃⁻, etc. The betaine monomer preferably has quaternary ammonium as the cation. Furthermore, the betaine monomer more preferably has quaternary ammonium as the cation and a sulfoxy group (—SO₃⁻) as the anion. The betaine monomer may be used alone or two or more thereof may be used in combination.

The betaine monomer has one or more polymerizable functional groups such as an acryloyl group or a methacryloyl group (hereinafter may also referred to as “(meth)acryloyl” group) in addition to the betaine structure. The polymerizable functional group is not particularly limited. Examples thereof include a (meth)acryloylaminoalkyl group that includes an alkyl group having 1 to 4 carbon atoms, a (meth)acryloyloxyalkyl group that includes an alkyl group having 1 to 4 carbon atoms, etc.

Examples of the (meth)acryloylaminoalkyl group that includes an alkyl group having 1 to 4 carbon atoms include a (meth)acryloylaminomethyl group, a (meth)acryloylaminoethyl group, a (meth)acryloylaminopropyl group, a (meth)acryloylaminobutyl group, etc. Examples of the (meth)acryloyloxyalkyl group that includes an alkyl group having 1 to 4 carbon atoms include a (meth)acryloyloxymethyl group, a (meth)acryloyloxyethyl group, a (meth)acryloyloxypropyl group, a (meth)acryloyloxybutyl group, etc.

A betaine monomer having quaternary ammonium as the cation and a sulfoxy group (—SO₃⁻) as the anion is not particularly limited. Examples thereof include N-(meth)acryloyloxyalkyl-N,N-dimethylammoniumalkyl-α-sulfobetaine, N-(meth)acryloyloxyalkoxyanelkoxy-N,N-dimethylammoniumalkyl-α-sulfobetaine, N,N-di(meth)acryloyloxyalkyl-N-methylammoniumalkyl-α-sulfobetaine, N,N,N-tri(meth)acryloyloxyalkylammoniumalkyl-α-sulfobetaine, etc.

A betaine monomer having quaternary ammonium as the cation and a carboxylate group (—CO₂⁻) as the anion is not particularly limited. Examples thereof include N-(meth)acryloyloxyalkyl-N,N-dimethylammonium-α-carboxylbetaine, N,N-di(meth)acryloyloxyalkyl-N-methylammonium-α-carboxylbetaine, N,N,N-tri(meth)acryloyloxyalkylammonium-α-carboxylbetaine, etc.

A compound having an alkoxysilyl group is not particularly limited. For example, the compound preferably has at least one alkoxy group having 1 to 4 carbon atoms in a molecule. Furthermore, in addition to the above, the compound preferably has a mercapto group represented by (—R₁—SH) in a molecule. In the above case, R₁ denotes an alkylene group having 1 to 12 carbon atoms. Specific examples of such a compound include 2-mercaptomethyl trimethoxy silane, 2-mercaptoethyl trimethoxy silane, 2-mercaptopropyl trimethoxy silane, 2-mercaptobutyl trimethoxy silane, 2-mercaptomethyl triethoxy silane, 2-mercaptoethyl triethoxy silane, 2-mercaptopropyl triethoxy silane, 2-mercaptobutyl triethoxy silane, 2-mercaptomethyl tripropoxy silane, 2-mercaptoethyl tripropoxy silane, 2-mercaptopropyl tripropoxy silane, 2-mercaptobutyl tripropoxy silane, 2-mercaptomethyltributoxy silane, 2-mercaptoethyl tributoxy silane, 2-mercaptopropyl tributoxy silane, 2-mercaptobutyl tributoxy silane, etc.

The compound having an alkoxysilyl group is preferably a compound in which two molecules of the compound having at least one alkoxy group having 1 to 4 carbon atoms in a molecule are linked via an azo group. This improves abrasion resistance of the resulting hydrophilic film. In addition to the alkoxysilyl group, the compound may also have a methylene group, an —O— group, a —C(O)O— group, a —O(O)C— group, an —NH—group, a —CO— group, an arylene group, a urethane bond, a 1,2-imidazoline group, etc. Specific examples of such a compound include 2,2′-azobis[2-(1-(trimethoxysilylpropylcarbamoyl)-2-imidazoline-2-yl)propane], 2,2′-azobis[2-(1-(triethoxysilylpropylcarbamoyl)-2-imidazoline-2-yl)propane], 2,2′-azobis[2-(1-(tripropoxysilylpropylcarbamoyl)-2-imidazoline-2-yl)propane], 2,2′-azobis[N—[2-(trimethoxysilylpropylcarbamoyl)ethyl]isobutylamide], 2,2′-azobis[N—[2-(triethoxysilylpropylcarbamoyl)ethyl]isobutylamide], 2,2′-azobis[N—[2-(tripropoxysilylpropylcarbamoyl)ethyl]isobutylamide], etc.

A compound having a silanol group is not particularly limited. For example, it can be obtained by hydrolyzing an alkoxysilyl group in the compound having an alkoxysilyl group to form a silanol group. In addition to this method, the compound having a silanol group can also be obtained by reacting silyl chloride such as trimethylsilyl chloride and dimethyl(t-butyl)chloride with an active hydrogen-containing compound.

The compound having an alkoxysilyl group or a silanol group may be used alone or two or more thereof may be used in combination.

An amount of the compound having an alkoxysilyl group or a silanol group contained in the hydrophilic polymer (A) is preferably 0.01 to 30 parts by mass per 100 parts by mass of the hydrophilic polymer (A).

The hydrophilic polymer (A) may contain a compound other than the betaine monomer or the compound having an alkoxysilyl group or a silanol group unless the effect of the present invention is impaired. Such a compound is not particularly limited and those conventionally known may be used.

A method for polymerizing the betaine monomer with the compound having an alkoxysilyl group or a silanol group to obtain the hydrophilic polymer (A) is not particularly limited. For example, a solution polymerization method in which components are dissolved in a solvent and polymerized with the addition of a polymerization initiator as necessary may be used. An amount of the solvent is not particularly limited. For example, the amount may be adjusted so as to give a concentration of monomer components in a solution of 10 to 80% by mass.

### Hydrophilic Polymer (B)

A hydrophilic polymer (B) may be at least one selected from an ionizable hydrophilic polymer having an ionic functional group and a non-ionic hydrophilic polymer having a polar functional group. Inclusion of the hydrophilic polymer (B) in the hydrophilizing agent provides favorable moist heat resistance and scratch resistance to the resulting hydrophilic film. The hydrophilic polymer (B) is preferably the ionizable hydrophilic polymer having an ionic functional group.

The reason why the inclusion of the hydrophilic polymer (B) in the hydrophilizing agent provides the above-mentioned effect is not known. However, it was confirmed that an ionically cross-linked network was formed between the hydrophilic polymer (A) and the hydrophilic polymer (B) when the hydrophilic film formed with the hydrophilizing agent according to the present embodiment containing the hydrophilic polymer (A) and the ionizable hydrophilic polymer having an ionic functional group (B) was measured by FT-IR. This is believed to be the reason why the resulting hydrophilic film has favorable scratch resistance as compared to conventional hydrophilizing agents. Moreover, the film mainly formed of the ionically cross-linked network has no functional group that may decrease hydrophilicity by a chemical reaction under a moist heat environment. This is believed to be the reason why the resulting hydrophilic film is less likely to decrease in hydrophilicity under a moist heat environment. Furthermore, it is believed that a hydrophilizing agent containing the hydrophilic polymer (A) and the non-ionic hydrophilic polymer having a polar functional group (B) also achieves similar effects to those described above due to formation of a network based on dipole-dipole interaction.

An ionic functional group contained in the hydrophilic polymer having an ionic functional group (B) is preferably an anionic functional group or an amphoteric functional group and more preferably an anionic functional group. The anionic functional group is not particularly limited, but is preferably any of a carboxy group and a sulfo group.

A hydrophilic polymer having a carboxy group (B) is not particularly limited. Examples thereof include polyacrylic acid, sodium polyacrylate, ammonium polyacrylate, a maleic anhydride copolymer, an itaconic acid copolymer, and derivatives thereof, etc.

A hydrophilic polymer having a sulfo group (B) is not particularly limited. Examples thereof include polyvinyl sulfonic acid, polystyrene sulfonic acid, polyallyl sulfonic acid, poly2-acrylamide-2-methylpropane sulfonic acid, polyisoprene sulfonic acid, a copolymer thereof with polyacrylic acid, ethyl polyacrylate sulfonate, butyl polyacrylate sulfonate, etc.

A hydrophilic polymer (B) having an amphoteric functional group is not particularly limited. Examples thereof include an allylamine-maleic acid copolymer, a styrene-acrylic acid-acrylic acid dialkylamino ester copolymer, an aminoethyl methacrylate-methacrylic acid copolymer, a methylaminoethyl methacrylate-acrylic acid copolymer, a vinylpyridine-maleic acid copolymer, vinylpyridine-itaconic acid copolymer, a methylallylamine-itaconic acid copolymer, etc.

A hydrophilic polymer (B) having a non-ionic polar functional group is a hydrophilic polymer having a non-ionic hydrophilic group. Examples of the hydrophilic polymer having a non-ionic polar functional group (B) include polyvinylpyrrolidone, a copolymer of vinylpyrrolidone and vinyl acetate, a copolymer of vinylpyrrolidone and a compound having a vinyl group, etc. In addition to the above, the hydrophilic polymer (B) may also be a hydrophilic polymer having a hydroxy group (B). Examples of the hydrophilic polymer having a hydroxy group (B) include polyvinyl alcohol, etc. The hydrophilic polymer having a non-ionic polar functional group is preferably polyvinylpyrrolidone or polyvinyl alcohol.

The hydrophilic polymer (B) may be one selected from those exemplified above or two or more thereof may be used in combination.

A molecular weight of the hydrophilic polymer (B) is not particularly limited, but is preferably 1000 to 1000000 in terms of weight average molecular weight. The weight average molecular weight is more preferably 5000 to 800000. This allows the resulting hydrophilic film to exhibit excellent moist heat resistance. Furthermore, the weight average molecular weight is further preferably 5000 to 50000. This provides favorable scratch resistance and moist heat resistance to the resulting hydrophilic film.

A ratio B/(A+B), a ratio of a solid mass of the hydrophilic polymer (B) to a total solid mass of the hydrophilic polymer (A) and the hydrophilic polymer (B), is preferably 1.0 to 51.0%. The ratio B/(A+B) is more preferably 5.0% to 23.8% from the viewpoint of favorable moist heat resistance of the resulting hydrophilic film. Furthermore, the ratio B/(A+B) is more preferably 5.0% to 38.5% from the viewpoint of favorable scratch resistance of the resulting hydrophilic film. In summary, the ratio B/(A+B) is most preferably 5.0% to 23.8%.

### Surfactant

The hydrophilizing agent according to the present embodiment may contain a surfactant. When the hydrophilizing agent contains the surfactant, components are well dispersed and the hydrophilizing agent can be more evenly applied upon application of the hydrophilizing agent. The surfactant is not particularly limited. Known anionic surfactants, cationic surfactants, non-ionic surfactants, etc. may be used.

### Other Components

The hydrophilizing agent according to the present embodiment may contain a component other than those mentioned above unless the effect of the present invention is not impaired. For example, another type of polymer component; a solvent such as water; and an inorganic salt such as NaCl, Na₂SO₄, KCl, KBr, KNO₃, K₂SO₄, CaCl₂, Si, Ti, alumina, etc. may be contained.

### Method for Preparing Hydrophilizing Agent

A method for preparing a hydrophilizing agent according to the present embodiment is not particularly limited. For example, the hydrophilic polymer (A) and the hydrophilic polymer (B), as well as other components are blended in predetermined amounts and stirred with the addition of a solvent such as water as necessary.

### Method for Applying Hydrophilizing Agent

A method for applying a hydrophilizing agent is a method for applying the resulting hydrophilizing agent as described above onto a substrate to form a hydrophilic film on a surface of the substrate. The substrate onto which the hydrophilizing agent is applied is not particularly limited. Examples thereof include an inorganic substrate for use in vehicles such as glass, aluminum, etc.; and an organic substrate such as PET, PC, PMMA, etc.

The method for applying a hydrophilizing agent includes, for example, a pretreatment step, a coating step, and a baking step.

The pretreatment step may include, for example, a polishing step which is a step of polishing the surface of the substrate to be coated with the hydrophilizing agent, and a cleaning step which is a step of cleaning a polishing agent, etc. The polishing step may be performed using known polishing materials or polishing machines. In the cleaning step, a polishing material or organic matter remaining on the surface of the substrate is removed by, for example, water cleaning, UV cleaning, etc. In the case where the water cleaning is performed as the cleaning step, a drying step is preferably added after the cleaning step. When an inorganic substrate such as glass is used as the substrate, the pretreatment step includes the polishing step and the cleaning step, and preferably, after the polishing step, water cleaning and UV cleaning are performed as the cleaning step. When the organic substrate is used as the substrate, the pretreatment step includes the cleaning step and preferably UV cleaning is performed as the cleaning step. Furthermore, when the organic substrate is used, a primer treatment may be performed instead of the cleaning step or after the cleaning step.

The coating step is a step of coating a surface of a substrate with a hydrophilizing agent. A method for coating the substrate is not particularly limited. For example, a method in which a substrate is dipped into a hydrophilizing agent, a method using a bar coater or a spin coater, etc. may be used.

The baking step is a step of baking a substrate that has been coated with a hydrophilizing agent. The method for applying a hydrophilizing agent according to the present embodiment may not include the baking step, but the baking step is preferably included since a cross-linking reaction between the substrate and a silanol group, etc. contained in the hydrophilizing agent is promoted. A baking temperature and a baking time are not particularly limited. For example, baking may be performed under a condition at 120° C. for 15 min.

Preferred embodiments of the present invention have been described above, but the present invention is not limited to the above embodiments and those with modifications as appropriate are also encompassed in the scope of the present invention providing that the effect of the present invention is not impaired.

### EXAMPLES

The present invention will be described in more detail with reference to Examples. The present invention is not limited to the following Examples.

### Preparation of Hydrophilizing Agent

### Example 1

A PTFE rotor with a length of 20 mm and a diameter of 7 mm was placed in a 500 ml disposable cup. Raw materials described in Table 1 were blended based on calculated solid contents while the rotor was slowly rotated. The rotor was then rotated at 400 rpm for 10 minutes to agitate the blend. Thus, a hydrophilizing agent of Example 1 was prepared.

### Examples 2~27, Comparative Examples 1~9

Hydrophilizing agents of Examples 2 to 27 and Comparative Examples 3 to 9 were prepared in the same manner as in Example 1, except that the raw materials to be blended were changed as described in Tables 1 and 2. The raw materials described in Tables 1 and 2 were as described below. Furthermore, a surfactant was added in a predetermined amount in the Examples and Comparative Examples. Note that, numerical values in Tables 1 and 2 represent solid contents (parts by mass) of components and, for Comparative Examples 1 and 2, commercially available silicate-based hydrophilizing agents described below were used. Comparative Example 1: SURFCOAT AF1 (manufactured by Nippon Paint Surf Chemicals Co., Ltd.) Comparative Example 2: EXCEL PURE BD-S01 (manufactured by CENTRAL AUTOMOTIVE PRODUCTS LTD.)

AMK: AMOGEN K (lauryl dimethylaminoacetic acid betaine, manufactured by DKS Co. Ltd.)
1000 W: LAMBIC-1000 W (betaine structure, and silanol group-containing hydrophilic polymer, manufactured by OSAKA ORGANIC CHEMICAL INDUSTRY LTD.)
771W: LAMBIC-771W (betaine structure, and silanol group-containing hydrophilic polymer, manufactured by OSAKA ORGANIC CHEMICAL INDUSTRY LTD.)
10L: JURYMER AC-10L (polyacrylic acid, weight average molecular weight: 50000, manufactured by TOAGOSEI CO., LTD.)
10H: JURYMER AC-10H (polyacrylic acid, weight average molecular weight: 800000, manufactured by TOAGOSEI CO., LTD.)
10SL: ARON A-10SL (polyacrylic acid, weight average molecular weight: 5000, manufactured by TOAGOSEI CO., LTD.)
AN: SHALLOL AN-103P (sodium polyacrylate, weight average molecular weight: 10000, manufactured by DKS Co. Ltd.)
AH: SHALLOL AH-103P (ammonium polyacrylate, weight average molecular weight: 10000, manufactured by DKS Co. Ltd.)
PA-PS: ARON A-12SL (copolymer of acrylic acid and 2-acrylamide-2-methylpropane sulfonic acid, weight average molecular weight: 10000, manufactured by TOAGOSEI CO., LTD.)
PAA: PAA-1151 (allylamine-maleic acid copolymer, manufactured by NITTOBO MEDICAL CO., LTD.)
PVA: PVA-105MC (polyvinyl alcohol-based resin, degree of saponification: 98 to 99%, degree of polymerization: 500, manufactured by Kuraray Co., Ltd.)
PVP: PITZCOL K-90L (polyvinylpyrrolidone, weight average molecular weight: 1200000, manufactured by DKS Co. Ltd.)
NaCl: Sodium chloride (Cica 1st grade, manufactured by manufactured by KANTO CHEMICAL CO., INC.)
KCl: Potassium chloride (Wako 1st grade, manufactured by FUJIFILM Wako Pure Chemical Corporation)
KBr: Potassium bromide (JUNSEI 1st grade, manufactured by JUNSEI CHEMICAL CO., LTD.)
Si: SNOWTEX O (colloidal silica, manufactured by Nissan Chemical Corporation)
Ti: TAINOC M-6 (titanium oxide sol, manufactured by Taki Chemical Co., Ltd.)
Alumina: Alumina sol 520-A (alumina sol, manufactured by Nissan Chemical Corporation)

TABLE 1

| | Hydrophilic polymer (A) | | | Hydrophilic polymer (B) | | | | | | | | | Inorganic salt | | | | | | B/ (A+B) |
|---|---|---|---|---|---|---|---|---|---|---|---|---|---|---|---|---|---|---|---|
| | | | | Anionic | | | | | | Amphoteric | Non-ionic | | | | | | | | |
| | AMK | 1000W | 771W | 10L | 10H | 10SL | AN | AH | PA-PS | PAA | PVA | PVP | NaCl I | KCl | KBr | Si | Ti | Alumina | |
| Example1 | - | 90.6 | - | 9.4 | - | - | - | - | - | - | - | - | - | - | - | - | - | - | 9.4% |
| Example2 | - | - | 90.6 | 9.4 | - | - | - | - | - | - | - | - | - | - | - | - | - | - | 9.4% |
| Example3 | - | - | 90.6 | - | - | - | - | - | 9.4 | - | - | - | - | - | - | - | - | - | 9.4% |
| Example4 | - | - | 90.6 | - | - | - | - | - | - | 9.4 | - | - | - | - | - | - | - | - | 9.4% |
| Example5 | - | - | 90.6 | - | - | - | - | - | - | - | 9.4 | - | - | - | - | - | - | - | 9.4% |
| Example6 | - | - | 90.6 | - | - | - | - | - | - | - | - | 9.4 | - | - | - | - | - | - | 9.4% |
| Example7 | - | - | 99.0 | 1.0 | - | - | - | - | - | - | - | - | - | - | - | - | - | - | 1.0% |
| Example8 | - | - | 95.0 | 5.0 | - | - | - | - | - | - | - | - | - | - | - | - | - | - | 5.0% |
| Example9 | - | - | 82.7 | 17.3 | - | - | - | - | - | - | - | - | - | - | - | - | - | - | 17.3% |
| Example10 | - | - | 76.2 | 23.8 | - | - | - | - | - | - | - | - | - | - | - | - | - | - | 23.8% |
| Example11 | - | - | 61.5 | 38.5 | - | - | - | - | - | - | - | - | - | - | - | - | - | - | 38.5% |
| Example12 | - | - | 54.6 | 45.4 | - | - | - | - | - | - | - | - | - | - | - | - | - | - | 45.4% |
| Example13 | - | - | 49.0 | 51.0 | - | - | - | - | - | - | - | - | - | - | - | - | - | - | 51.0% |
| Example14 | - | - | 90.9 | 9.1 | - | - | - | - | - | - | - | - | - | - | - | - | - | - | 9.1% |
| Example15 | - | - | 90.6 | - | - | - | 9.4 | - | - | - | - | - | - | - | - | - | - | - | 9.4% |
| Example16 | - | - | 90.6 | - | - | - | - | 9.4 | - | - | - | - | - | - | - | - | - | - | 9.4% |
| Example17 | - | - | 90.6 | - | 9.4 | - | - | - | - | - | - | - | - | - | - | - | - | - | 9.4% |
| Example18 | - | - | 90.6 | - | - | 9.4 | - | - | - | - | - | - | - | - | - | - | - | - | 9.4% |
| Example19 | - | - | 90.6 | 9.4 | - | - | - | - | - | - | - | - | - | - | - | - | - | - | 9.4% |
| Example20 | - | - | 90.6 | 9.4 | - | - | - | - | - | - | - | - | - | - | - | - | - | - | 9.4% |
| Example21 | - | - | 90.6 | 9.4 | - | - | - | - | - | - | - | - | - | - | - | - | - | - | 9.4% |
| Example22 | - | - | 81.5 | 8.5 | - | - | - | - | - | - | - | - | 10.0 | - | - | - | - | - | 9.4% |
| Example23 | - | - | 81.5 | 8.5 | - | - | - | - | - | - | - | - | - | 10.0 | - | - | - | - | 9.4% |
| Example24 | - | - | 81.5 | 8.5 | - | - | - | - | - | - | - | - | - | - | 10.0 | - | - | - | 9.4% |
| Example25 | - | - | 81.5 | 8.5 | - | - | - | - | - | - | - | - | - | - | - | 10.0 | - | - | 9.4% |
| Example26 | - | - | 81.5 | 8.5 | - | - | - | - | - | - | - | - | - | - | - | - | 10.0 | - | 9.4% |
| Example27 | - | - | 81.5 | 8.5 | - | - | - | - | - | - | - | - | - | - | - | - | - | 10.0 | 9.4% |

TABLE 2

| | Hydrophilic polymer (A) | | | Hydrophilic polymer (B) | | | | | | | | | Inorganic salt | | | | | | B/ (A+B) |
|---|---|---|---|---|---|---|---|---|---|---|---|---|---|---|---|---|---|---|---|
| | | | | Anionic | | | | | | Amphoteric | Non-ionic | | | | | | | | |
| | AMK | 1000W | 771W | 10L | 10H | 10SL | AN | AH | PA-PS | PAA | PVA | PVP | NaCl | KCl | KBr | Si | Ti | Alumina | |
| Comparative Example1 | - | - | - | - | - | - | - | - | - | - | - | - | - | - | - | - | - | - | - |
| Comparative Example2 | - | - | - | - | - | - | - | - | - | - | - | - | - | - | - | - | - | - | - |
| Comparative Example3 | - | 100.0 | - | - | - | - | - | - | - | - | - | - | - | - | - | - | - | - | 0.0% |
| Comparative Example4 | - | - | 100.0 | - | - | - | - | - | - | - | - | - | - | - | - | - | - | - | 0.0% |
| Comparative Example5 | 90.6 | - | - | 9.4 | - | - | - | - | - | - | - | - | - | - | - | - | - | - | 9.4% |
| Comparative Example6 | - | - | 91.3 | - | - | - | - | - | - | - | - | - | 8.7 | - | - | - | - | - | 0.0% |
| Comparative Example7 | - | - | 40.0 | - | - | - | - | - | - | - | - | - | 60.0 | - | - | - | - | - | 0.0% |
| Comparative Example8 | - | - | 20.0 | - | - | - | - | - | - | - | - | - | 80.0 | - | - | - | - | - | 0.0% |
| Comparative Example9 | - | - | - | 100.0 | - | - | - | - | - | - | - | - | - | - | - | - | - | - | 100.0% |

### Application of Hydrophilizing Agent

As a substrate onto which the hydrophilizing agent was applied, a glass substrate (manufactured by Matsunami Glass Ind., Ltd. S9213 (76 × 52 mm) was used for Examples 1 to 18, Examples 22 to 27, and Comparative Examples 1 to 9. A PET substrate, a PC substrate, and a PMMA substrate were used for Examples 19, 20, and 21, respectively. The glass substrate used for Examples 1 to 18, Examples 22 to 27, and Comparative Examples 1 to 9 was pretreated with KIIROBIN GOLD (manufactured by Prostaff Co. Ltd.) prior to the application. The substrate was pretreated as follows: the substrate was subjected to a polishing pretreatment using PROXXON micropolisher with Japan wool pad 50, and then, KIIROBIN GOLD was cleaned with pure water, and the substrate was dried by a dryer. The substrates used for Examples 19 to 21 were pretreated by UV cleaning. After the pretreatment, the substrate was measured for a contact angle as described below. When the contact angle was confirmed to be 10° or less, the hydrophilizing agent was applied onto the substrates. When the contact angle was greater than 10°, the substrate was pretreated again.

The thus-pretreated substrate was coated by dipping into the hydrophilizing agent of each of Examples and Comparative Examples prepared as described above. A setting time was 1 min. Then, the glass substrates that had been coated with Examples 1 to 18, Examples 22 to 27, and Comparative Examples 1 to 9 were baked under a condition at 120° C. for 15 min. The PET, PC, and PMMA substrates that had been coated with Examples 19 to 21 were baked under a condition at 80° C. for 30 min. Thus, samples for Examples and Comparative Examples were made.

The samples for Examples and Comparative Examples were evaluated by the below-mentioned method. The results are shown in Table 3.

### Hydrophilicity

Five micro-milliliters of pure water was dropped onto a surface of the substrate for each of the samples under an environment at 25° C. and 50% RH and a contact angle was measured. As a measurement device, an automatic contact angle meter DM501 (manufactured by Kyowa Interface Science Co., Ltd.) was used. Hydrophilicity was evaluated based on the following criteria and 3 was considered as acceptable.
3 Contact angle of 10° or less
2 Contact angle of more than 10° but 20° or less
1 Contact angle of more than 20°

### Anti-Fog Property

A degree of fog when breathed on a surface of the substrate for each of the samples under an environment at 25° C. and 50%RH was evaluated based on the following criteria and 3 or more was considered as acceptable.
4 No fog
3 No fog, but slightly unevenly wet-spread water film.
2 No fog, but considerably unevenly wet-spread water film.
1 Fog

### Scratch Resistance Test

A piece of nonwoven fabric (Product name: elleair PROWIPE Strong Towel E50, manufactured by Daio Paper Corporation) was brought into contact with a surface of the substrate for each of the samples of Examples and Comparative Examples and moved back and forth 100 times with a load of 500 g. Thereafter, each of the samples was evaluated according to the above-mentioned criteria for hydrophilicity and anti-fog property.

### Moist Heat Resistance Test

Each of the samples of Examples and Comparative Examples was exposed to a moist heat environment at 60° C. and 90%RH for 24 hours. Thereafter, each of the samples was evaluated according to the above-mentioned criteria for hydrophilicity and anti-fog property. Furthermore, the samples of Example 2, Comparative Example 1, and Comparative Example 4 were tested for moist heat resistance under the above-mentioned condition for 5 days, 10 days, 15 days, and 20 days. Thereafter, each of the samples was measured for a contact angle (°) according to the above-mentioned method for hydrophilicity. The results are shown in Table 1.

TABLE 3

| | Initial | | After moist heat resistance test | | After scratch resistance test | |
|---|---|---|---|---|---|---|
| | Hydrophilicity | Anti-fog property | Hydrophilicity | Anti-fog property | Hydrophilicity | Anti-fog property |
| Example1 | 3 | 4 | 3 | 3 | 3 | 3 |
| Example2 | 3 | 4 | 3 | 4 | 3 | 4 |
| Example3 | 3 | 4 | 3 | 4 | 3 | 4 |
| Example4 | 3 | 4 | 3 | 3 | 3 | 4 |
| Example5 | 3 | 4 | 3 | 3 | 3 | 4 |
| Example6 | 3 | 4 | 3 | 3 | 3 | 4 |
| Example7 | 3 | 4 | 3 | 3 | 3 | 3 |
| Example8 | 3 | 4 | 3 | 4 | 3 | 4 |
| Example9 | 3 | 4 | 3 | 4 | 3 | 4 |
| Example10 | 3 | 4 | 3 | 4 | 3 | 4 |
| Example11 | 3 | 4 | 3 | 3 | 3 | 4 |
| Example12 | 3 | 4 | 3 | 3 | 3 | 3 |
| Example13 | 3 | 4 | 3 | 3 | 3 | 3 |
| Example14 | 3 | 4 | 3 | 4 | 3 | 4 |
| Example15 | 3 | 4 | 3 | 4 | 3 | 4 |
| Example16 | 3 | 4 | 3 | 4 | 3 | 4 |
| Example17 | 3 | 4 | 3 | 4 | 3 | 3 |
| Example18 | 3 | 4 | 3 | 4 | 3 | 4 |
| Example19 | 3 | 4 | 3 | 4 | 3 | 3 |
| Example20 | 3 | 4 | 3 | 4 | 3 | 3 |
| Example21 | 3 | 4 | 3 | 4 | 3 | 3 |
| Example22 | 3 | 4 | 3 | 4 | 3 | 4 |
| Example23 | 3 | 4 | 3 | 4 | 3 | 4 |
| Example24 | 3 | 4 | 3 | 4 | 3 | 4 |
| Example25 | 3 | 4 | 3 | 3 | 3 | 4 |
| Example26 | 3 | 4 | 3 | 3 | 3 | 4 |
| Example27 | 3 | 4 | 3 | 3 | 3 | 4 |
| Comparative Example1 | 3 | 4 | 1 | 1 | 1 | 2 |
| Comparative Example2 | 3 | 4 | 1 | 1 | 2 | 2 |
| Comparative Example3 | 3 | 4 | 2 | 2 | 2 | 2 |
| Comparative Example4 | 3 | 4 | 3 | 2 | 2 | 3 |
| Comparative Example5 | 3 | 3 | 1 | 1 | 1 | 1 |
| Comparative Example6 | 3 | 3 | 3 | 2 | 2 | 3 |
| Comparative Example7 | 3 | 3 | 2 | 2 | 2 | 3 |
| Comparative Example8 | 3 | 3 | 2 | 1 | 2 | 3 |
| Comparative Example9 | 3 | 3 | 1 | 1 | 2 | 3 |

As is clear from the evaluation results for Examples and Comparative Examples, it was confirmed that the hydrophilic films formed with the hydrophilizing agents of Examples achieved favorable hydrophilicity and anti-fog property and also maintained favorable hydrophilicity and anti-fog property after the moist heat resistance test and the scratch resistance as compared to the hydrophilic films formed with the hydrophilizing agents of Comparative Examples.

1. A hydrophilizing agent comprising:
a hydrophilic polymer (A) having a betaine structure, and at least one selected from an alkoxysilyl group and a hydrolysate thereof in a molecule; and
a hydrophilic polymer (B) being at least one selected from a hydrophilic polymer having at least one ionic functional group and a non-ionic hydrophilic polymer having a polar functional group,
with a ratio B/(A+B), a ratio of a solid mass of the hydrophilic polymer (B) to a total solid mass of the hydrophilic polymer (A) and the hydrophilic polymer (B) being 1.0 to 51.0%.

2. The hydrophilizing agent according to claim 1, wherein the hydrophilic polymer (A) has at least one selected from an alkoxysilyl group and a silanol group, at least at a terminal end in a molecule.

3. The hydrophilizing agent according to claim 1, wherein the at least one ionic functional group comprises a plurality of ionic functional groups and at least one of the plurality of ionic functional groups is an anionic functional group.

4. The hydrophilizing agent according to claim 1, wherein the ionic functional group comprises an ionic functional selected from a carboxy group and a sulfo group.

5. The hydrophilizing agent according to claim 2, wherein the at least one ionic functional group comprises a plurality of ionic functional groups and at least one of the plurality of ionic functional groups is an anionic functional group.

6. The hydrophilizing agent according to claim 2, wherein the ionic functional group comprises an ionic functional selected from a carboxy group and a sulfo group.

7. The hydrophilizing agent according to claim 3, wherein the ionic functional group comprises an ionic functional selected from a carboxy group and a sulfo group.
